(19) United States
(12) Patent Application Publication
(10) Pub. No.: US 2024/0349667 A1
(43) Pub. Date: Oct. 24, 2024

(54) SELF-WATERING DEVICE FOR CONTAINER PLANTS AND METHOD OF USING THE SAME

(71) Applicant: Cowbell Plant Co., Miami, FL (US)

(72) Inventor: Jeanna Liu, Miami, FL (US)

(21) Appl. No.: 18/641,008

(22) Filed: Apr. 19, 2024

Related U.S. Application Data
(60) Provisional application No. 63/497,391, filed on Apr. 20, 2023.

(51) Int. Cl. A01G 27/02; A01G 27/00

(52) U.S. Cl. CPC A01G 27/02; A01G 27/008

(57) ABSTRACT

A plant watering device includes a reservoir, a porous body, and a valve. The reservoir is configured to hold water therein and has first and second openings at opposing ends. The porous body covers the second opening and provides a flow pathway from the reservoir. The valve covers the first opening and is configured to close to inhibit airflow between the reservoir and an external environment when a differential pressure between the reservoir and atmospheric pressure is less than a preset opening pressure and open to permit airflow between the reservoir and the external environment when the differential pressure is greater than or equal to the preset opening pressure. When the reservoir contains water and is inserted in a medium to be watered, an opening pressure of the valve and a porosity of the porous body are configured to provide a selected flow rate of water therefrom.

### CROSS-REFERENCE TO RELATED APPLICATIONS

This application claims the benefit of U.S. Provisional Application. No. 63/497,391, filed on Apr. 20, 2023 and entitled “SELF-WATERING AND SELF-REGULATING NUTRIENT DELIVERY DEVICE FOR CONTAINER PLANTS AND METHOD OF USING THE SAME” the entirety of which is hereby incorporated by reference.

### FIELD OF THE DISCLOSURE

This disclosure pertains to a device for watering and/or fertilizing plants including a water reservoir, a soil spike, and a lid for creating a substantially airtight seal. A method of using the device for self-watering and/or nutrient delivery to container plants is also disclosed, whereby the process of watering and/or nutrient delivery is regulated by the plant without user intervention over the course of 1-2 weeks, or longer.

### BACKGROUND OF THE DISCLOSURE

Plant watering devices currently on the market are often flawed in that most do not successfully regulate the amount of water flow relative to the amount consumed by the plant and lost to ambient air. Often these types of devices drain out in as little as one day because the rate of water delivery relies almost entirely on atmospheric pressure and gravity. This results in over- or under-watering, which can create a rich environment for pest growth (e.g. fungus gnats, mealy bugs, spider mites) and facilitate common plant diseases (e.g. root rot, mold, fungal infections, powdery mildew, leaf spot) that lead to suboptimal plant growth and ultimately premature plant death.

In addition, existing watering devices on the market are not configured to be easily refillable and often cannot contain enough water for the intended purpose of watering an average houseplant for an extended duration (e.g., at least two weeks) while unattended.

Further, many plant owners do not properly fertilize their plants, if at all. This is usually a flaw of fertilizer manufacturers, since existing consumer fertilizers are often messy and manufacturers do not instruct users how to properly dilute or measure the right amount required for houseplants.

Accordingly, there is an ongoing need for devices that provide the right amount of nutrients and/or water to container or house plants.

### SUMMARY OF THE DISCLOSURE

In an embodiment, a plant watering device is provided. The device may also provide nutrients to the plant, optionally derived from a water-soluble fertilizer.

The device includes a reservoir, a porous body, and a valve. The reservoir is configured to hold water therein and has a first opening at one end and a second opening at the opposing end. The porous body covers the second opening and provides a flow pathway from the reservoir. The valve covers the first opening of the reservoir and is configured to close to inhibit airflow between the reservoir and an external environment when a differential pressure between the reservoir and atmospheric pressure is less than a preset opening pressure and is configured to open to permit airflow between the reservoir and the external environment when the differential pressure is greater than or equal to the preset opening pressure.

So configured, the valve and porous body can be configured to achieve an equilibrium state of the device in air (outside of soil or other medium to be watered) in which water is substantially inhibited from flowing out of the reservoir. In this equilibrium state, the force due to the weight of water within the reservoir is countered by resistance to flow from the reservoir due to vacuum developed within the reservoir and porosity of the porous body. As a result, when the device is inserted into soil or other medium to be watered, further forces due to the soil and/or roots of nearby plants act to draw water out of the device. In this manner, the soil or medium and plant can absorb water from the device as needed. The opening pressure of the valve and porosity of the porous body are configured to provide a selected flow rate of water from the reservoir to the soil or medium to be watered.

In another embodiment, the first opening of the reservoir is dimensioned to permit receipt of water therein to fill the reservoir, and the valve is formed within a lid.

In another embodiment, the porous body is a hollow cone.

In another embodiment, the device further includes a soil spike including the hollow cone and a hollow conical outer protective body that is configured to receive the porous body and to detachably connect to the second opening of the reservoir.

In another embodiment, the outer protective body is in the form of a spike that includes a plurality of struts and apertures therebetween.

In another embodiment, the outer protective body has a length of about 5 cm to about 50 cm.

In another embodiment, the valve is a one-way valve.

In another embodiment, the valve is an umbrella valve.

In another embodiment, the water reservoir may have a neck portion including a protruding edge configured to receive and be detachably connected to the soil spike.

In another embodiment, the porous body is formed from one or more ceramic materials.

In another embodiment, the porous body is formed from at least one of alumina (Al₂O₃), silica (SiO₂), lime (CaO), magnesia (MgO), hematite (Fe₂O₃), soda (Na₂O), titania (TiO₂), or potash (K₂O).

In another embodiment, absent the valve, the porous body has a porosity that is configured to result in delivery of water from the reservoir under only the force of atmospheric pressure at a flow rate ranging between about 10 mL to about 120 mL.

In another embodiment, the reservoir is configured to hold a volume ranging between about 50 mL to about 2 L.

In another embodiment, the reservoir may be formed from a plastic material.

In another embodiment, the reservoir may be formed in a rounded triangle prism shape.

In an embodiment, a kit for delivering water and/or nutrients to a container plant is provided. The kit includes the above-discussed plant watering device and a water-soluble fertilizer.

In another embodiment, the fertilizer may fully dissolve in water within about 60 seconds.

In another embodiment, the fertilizer can be in pre-apportioned tablet or powder or liquid form.

In an embodiment, a method of watering a plant is provided. The method includes assembling the device for water delivery to a plant discussed above; inserting the soil spike of the assembled device into soil beside the plant; adding water through the opening at the top of the reservoir; and sealing the opening by attaching the lid in which the valve is formed. The water permeates through the porous body and nourishes the plant for a period of time over 1 week.

In an embodiment, the method further includes adding a fertilizer to the water prior to sealing the opening.

In another embodiment, the method may further include waiting about 10 to about 30 minutes after adding water, then refilling to the capacity of the reservoir, before sealing with the lid.

In another embodiment, the water permeates through the porous body and nourishes the plant for a period of time over 2 weeks.

In another embodiment, the water permeates through the porous body and nourishes the plant for a period of time over about 2 weeks to about 4 weeks.

In another embodiment, after depletion of the water from the reservoir, the method may further include: removing the lid; adding water through the opening at the top of the water reservoir; optionally waiting about 10 to about 30 minutes; refilling to the capacity of the reservoir, and sealing the opening by attaching the lid.

### BRIEF DESCRIPTION OF THE DRAWINGS

These and other features will be more readily understood from the following detailed description taken in conjunction with the accompanying drawings, in which:

FIG. 1 is a drawing of the device including a water reservoir, soil spike, and lid.

FIG. 2 is a drawing of a disassembled device including a water reservoir, soil spike, lid, and gaskets.

FIG. 3A is drawing of a top view of a rounded triangle prism-shaped water reservoir.

FIG. 3B is drawing of a bottom view of a rounded triangle prism-shaped water reservoir attached to the soil spike.

FIG. 4 is a drawing of a cross-sectional view of a two-piece lid having an umbrella valve therein.

FIG. 5 is a drawing of a bottom perspective view of a bottom piece of the two-piece lid of FIG. 4.

It is noted that the drawings are not necessarily to scale. The drawings are intended to depict only typical aspects of the subject matter disclosed herein, and therefore should not be considered as limiting the scope of the disclosure.

### DETAILED DESCRIPTION OF THE DISCLOSURE

A plant watering device is disclosed. A system for delivering water and/or nutrients to a container plant including the plant watering device, and optionally a water-soluble fertilizer is also disclosed. This system is a self-watering device designed for use in watering and/or fertilizing container plants. The system may include or be used with a water-soluble fertilizer that may be added to, dropped in, or inserted into a water reservoir of the system, which slowly waters, and also optionally, fertilizes the plant. The system may be used to provide water and/or nutrients to one or more plants in a window box, or in a garden where the plant is growing directly in the ground.

A container plant may be any plant that is grown in a container rather than directly in the ground. Container plants are typically smaller and more manageable than their in-ground counterparts, making them ideal for indoor or outdoor decoration, as well as for gardeners with limited space. They can range from small herbs or flowering annuals to larger shrubs or even trees, and are often selected for their ornamental value or practical uses such as producing herbs or vegetables.

Container plants require proper watering, soil, and fertilization management, as well as adequate drainage to thrive in their confined space. Self-watering as used herein encompasses its ordinary and customary meaning as understood by one skilled in the art. Self-watering can mean that as, the plant absorbs moisture from the soil, it affects the moisture equilibrium between the inner hollow cone and the soil. As a result, more water then permeates from the plant watering device into the soil. As such, the plant regulates the release of the liquid from the water reservoir of the plant watering device.

As discussed in greater detail below, the plant watering device can be modular and may be assembled and disassembled for more efficient shipping, customization of individual parts, and easy replacement. The reservoir may be tall and slim, with an offset reservoir for a usefully large capacity, while offering a smaller footprint inside a pot of soil vs a non-offset reservoir. The result is good stability, while allowing maximum room inside the pot for the plant and easy access for refilling.

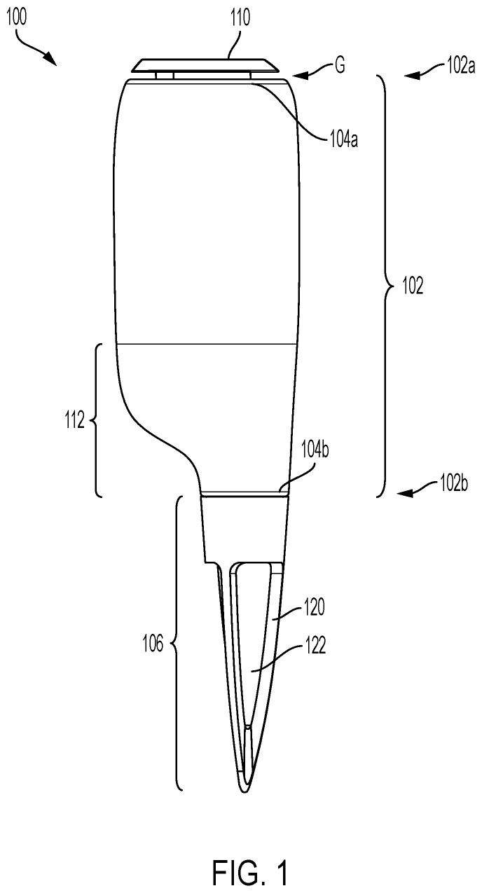

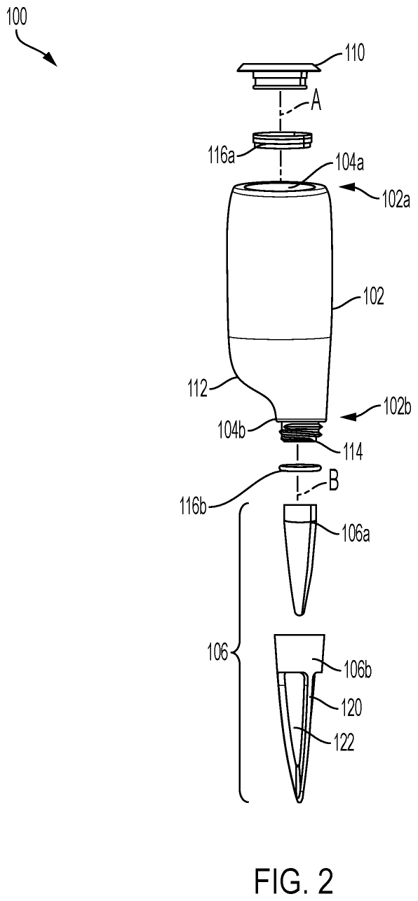

An embodiment of a plant watering device 100 is illustrated in FIGS. 1-2. As shown, the device 100 includes a water reservoir 102 extending between a top end 102a and a bottom end 102b and centered along a longitudinal axis A. The reservoir 102 has a first opening 104a at the top end 102a and a second opening 104b at the bottom end 102b, a water-permeable soil spike 106, and a lid 110 that is configured to detachably connect to the first opening 104a at the top end 102a of the water reservoir 102. The water-permeable soil spike 106 may be configured to be detachably connected to the second opening 104b at the bottom end 102b of the water reservoir 102. Optionally, the first opening 104a may be positioned such that the longitudinal axis A passes through the center of the first opening 104a.

The water reservoir 102 may have a neck 112 which is a narrowed end portion located at the bottom end 102b of the water reservoir 102. The neck 112 may include a protruding edge 114 that surrounds the second opening 104b, extends from the neck 112, and is configured to be attached, e.g. screwed, to the soil spike 106.

As shown in FIGS. 1-2, a longitudinal axis B extending through the center of the cross-section of the second opening 104b of the reservoir 102 and the soil spike 106 is not centered with respect to the longitudinal axis A of the water reservoir 102. That is, the longitudinal axis B is laterally offset to one side of the longitudinal axis A, which allows the device 100 to be anchored into the soil via the soil spike 106 much closer to the main trunk and root device of the plant than other watering devices on the market where the spike is in the center of its reservoir.

The water reservoir 102 can be of any shape and have a sufficient size to hold a predetermined amount of water (e.g., about 200 mL to about 3 Liters, about 1.5 L to about 2 L, or about 200 mL to about 1 L of water). The water reservoir may be a symmetrical or asymmetrical shape. The water reservoir may be cylindrical. The water reservoir may be a rounded triangle prism-shaped reservoir. This shape prevents rolling or breaking if accidentally knocked over, e.g., by pets, children or the weather.

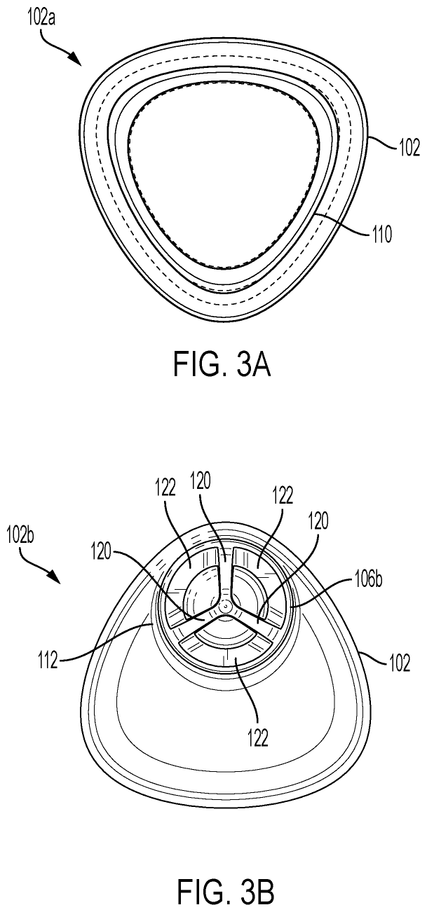

FIGS. 3A and 3B are drawings from a top and bottom view of the assembled device 100 of FIG. 1. In these figures, the triangular shape of the water reservoir 102 and the lid 110 is clearly visible, as well as the asymmetrical positioning of the neck 112 and soil spike 106 assembly within the device 100.

The water reservoir 102 is made of a water-tight material, and maintains an even rigidity throughout the entire structure. The rigidity of the water reservoir 102 (e.g., as characterized by stiffness, elastic modulus, etc.) can be at a level sufficient to allow the reservoir 102 to maintain its internal volume, within a given tolerance, during handling and use, such as during insertion into soil or other medium to be watered.

The water reservoir may comprise any material that meets the rigidity requirements. For example, the water reservoir 102 may be formed from glass, polyethylene terephthalate (PET), polyethylene (PE, including high-density HDPE), polypropylene (PP), polyvinyl chloride (PVC), polystyrene (PS), tritan copolyester (Tritan®), polycarbonate (PC), Acrylonitrile-butadiene-styrene (ABS), or any combination thereof. In certain embodiments, the water reservoir 102 may be formed from polyethylene terephthalate (PTFE; Teflon®) and may be fabricated by injection blow-molding to create a symmetrical or asymmetrical shape with one opening on each of the opposing sides and remain evenly rigid on all sides. In other embodiments, the water reservoir may be made from plastic that is free of bisphenol A (BPA) and bisphenol S (BPS), e.g., TRITAN® plastic.

The openings 104a, 104b of the reservoir 102 may be formed in any shape, for example, triangular, rectangular, or spherical.

Optionally, a lip or protruding edge (e.g., protruding edge 114) extending axially outward from the water reservoir 102 can be included or omitted. The first opening 104a at the top end 102a of the reservoir 102 can be configured to be detachably connected to the lid 110 and may have a triangular shape, with or without a protruding edge. The second opening 104b at the bottom 102b of the reservoir 102 can be configured for detachable connection to the soil spike 106 and may have a circular shape, with or without a protruding edge. When circular, the second opening 104b may have a diameter of about 1 cm to about 5 cm, about 1 cm to about 4 cm, or about 1.5 cm to about 3 cm. The protruding edge may be configured for the manner of attachment to the lid or soil spike being utilized, e.g., a screw thread, a stud or cap of a snap, etc.

One or more gaskets 116 (e.g., 116a, 116b) or other suitable seals may be used in accordance with the disclosure to ensure a tight seal between the lid 110 and the first opening 104a and between the soil spike 106 and the second opening 104b. Any gasket or seal material known for use in the art may be used herein. The gasket 116a on top end 102a of the water reservoir 102 may be designed to provide a gap G between the lid 110 and the water reservoir 102 for improved grip when removing for easy refill.

The soil spike 106 may include a porous body 106a and a protective outer body 106b. For example, the porous body 106a may be in the form of a water-permeable hollow inner cone and the protective outer body 106b may be configured to receive the porous body 106a therein, to be encased by the protective outer body. The water-permeable soil spike 106 (e.g., the protective outer body 106b) is designed to detachably and sealably attached to the second opening 104b at the bottom end 102b of the reservoir 102 and is designed to be inserted into soil or other medium to be watered. The protective outer body 106b is made of a rigid material and, thereby protects the porous body 106a from any accidental damage and extends its usable life.

The protective outer body 106b may be made of non-porous material, such as any hard or sufficiently rigid plastic, wood, glass or metal, and is not water permeable. The rigidity of the protective outer body 106b allows for ease of insertion and anchoring of the soil spike 106 into soil or other medium to be watered without the use of digging tools or having to use excessive downward force which can cause damage to the porous body 106a as well as the plant.

The wide end of the protective outer body 106b may include a mechanism for airtight and removable attachment to the protruding edge 114 of the water reservoir 102. For example, the outer body 106b can include threads configured to mate with threads of the protruding edge 114.

The protective outer body 106b may have a length of about 5 cm to about 50 cm (e.g., about 5 cm to about 25 cm, about 7 cm to about 20 cm, or about 7 cm to about 12 cm in length, or any number therebetween, such as about 5 cm, about 6 cm, about 7 cm, about 8 cm, about 9 cm, or about 10 cm in length) and a diameter of about 1 cm to about 7 cm (e.g., about 1.5 cm to about 5 cm, about 2 cm to about 4 cm, about 2 cm to about 3 cm, or about 2 cm to about 2.5 cm) at its widest part.

The protective outer body 106b may have a plurality of struts 120 with apertures 122 therebetween, when assembled and in use, to allow the porous body 106a to come in contact with the soil. There may be 2-5 equally spaced struts 120 with apertures 122 therebetween.

The water-permeable porous body 106a may be formed from a porous material that allows water to pass through and out of the device 100 into soil. The porous body 106a is constructed to allow slow and steady release of water to the surrounding soil or other medium to be watered and designed to maximize the surface area for the soil/medium and roots to engage.

In an embodiment, the porous material forming the porous body 106a can be inorganic, non-metallic oxide, nitride, and/or carbide materials. For example, the porous body 106a can be formed from one or more ceramics, including but not limited to, alumina (Al₂O₃), silica (SiO₂), lime (CaO), magnesia (MgO), hematite (Fe₂O₃), soda (Na₂O), titania (TiO₂), potash (K₂O), or any combination thereof. In further embodiments, The water-permeable hollow inner cone may be formed from ceramic particles of one or more of alumina (Al₂O₃), silica (SiO₂), lime (CaO), magnesia (MgO), hematite (Fe₂O₃), soda (Na₂O), titania (TiO₂), or potash (K₂O). In further embodiments, the water-permeable hollow inner cone may include alumina (Al₂O₃) in an amount of over 90 wt. %, optionally in combination with one or more of silica (SiO₂), lime (CaO), magnesia (MgO), hematite (Fe₂O₃), soda (Na₂O), titania (TiO₂), and potash (K₂O).

For example, Table 1 includes an example of a composition of the porous body 106a.

TABLE 1

| | % by weight of the total |
|---|---|
| Ceramic Material | composition of porous body |
| Al₂O₃ | about 90 wt. % to about 99 wt % |
| SiO₂ | about 0.5 wt. % to about 5 wt % |
| CaO | about 0.5 wt. % to about 5 wt % |
| MgO | about 0 wt. % to about 2 wt % |
| Fe₂O₃ | about 0 wt. % to about 2 wt % |
| Na₂O | about 0 wt. % to about 2 wt % |
| TiO₂ | about 0 wt. % to about 2 wt % |
| K₂O | about 0 wt. % to about 2 wt % |

The lid 110 is detachably connected to the water reservoir 102. Refilling the reservoir 102 is made easy and convenient via the detachable lid 110 on top end 102a of the water reservoir 102. The lid 110 may be elevated and position at the top end 102a of the water reservoir 102 for easy access, and it may be designed to be substantially flush with a top surface of the water reservoir 102 upon assembly. This is in contrast with existing products that require the entire unit to be removed from soil to be refilled, which often results in a mess of removed soil.

The lid 110 may be configured to fit in the first opening 104a at the top end 102a of the reservoir to create an airtight seal, which creates a vacuum within the water reservoir 102, and prevents significant spillage and/or evaporation of water.

The lid 110 may be formed of any pliable or rigid material for use in the art that can create the airtight seal. For example, the lid 110 may be made of any combination of glass, rubber, plastic, silicone, wood or metal, or any combination, or include a rubber or silicone gasket seal. The lid 110 may be of any shape needed to fit within the opening and create an airtight seal at the top of the water reservoir. For example, the lid may be circular or triangular. The lid may be a two-piece lid including a bottom piece and a top piece, which are fused together and are not detachable.

In situations where plants have been chronically underwatered and are extremely thirsty or live in high-absorption soil, or in situations where there are significant swings in ambient temperature throughout the day, the suction of the soil and root systems can create vacuum pressure (i.e., a pressure differential of −2.0 psi or more) in the air-tight water reservoir over 24 hours. In these instances, water can stop draining from the spike completely, halting the plant from receiving the hydration it needs.

To address these situations, the lid 110 can include a vacuum-release valve. The valve can be a one-way valve that, when attached to the reservoir 102, may release pressure build-up in the water reservoir 102 and allow the plant to absorb water again more easily. If fertilizer is added to water within the reservoir 102, the valve can also function to release any odors or gasses from the dissolution of fertilizer in the water reservoir 102 over time. Types of one way valves can include check valves, flapper valves, ball valves, foot valves, duckbill valves, silicone valves, umbrella valves.

Placing the vacuum-release valve in the lid 110 may also be useful to regulate the flow of water through the porous body 106a. The valve allows air to replace the water that has been drawn down. Thus, when present, the valve in the lid 110 may open once the internal pressure differential inside the container reaches a preset opening pressure.

In an embodiment, the valve can be an umbrella valve. The vacuum-release umbrella valve equalizes the pressure inside the reservoir 102 and allows water to flow again based on the plant's needs.

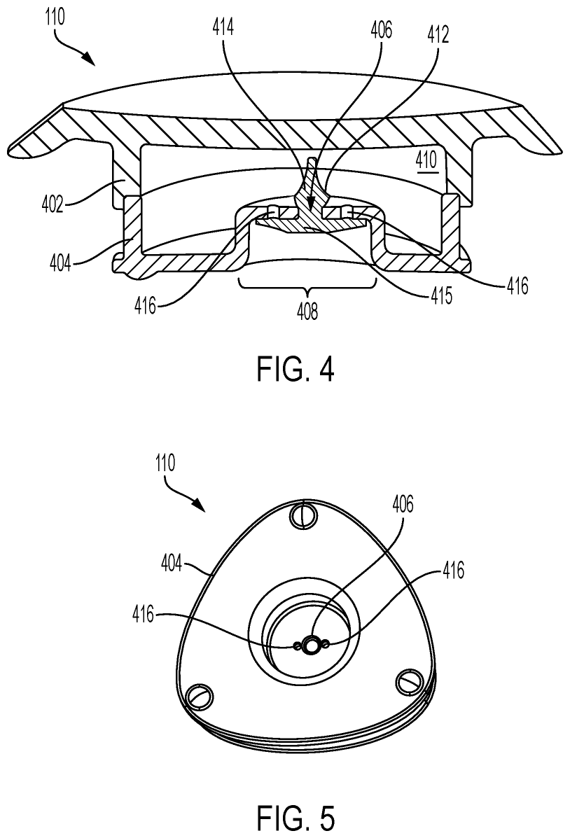

An embodiment of the lid 110 including a vacuum-release umbrella valve 408 is illustrated in FIG. 4. The lid 110 may include a top piece 402 and a bottom piece 404 having a center hole 406 therein. A sealing member 412 (e.g., silicone, rubber) is enclosed within a space 410 between the top piece 402 and the bottom piece 404 of the lid 110. For example, the scaling member 412 includes a shaft or stem 414 and a diaphragm-shaped sealing disk 415. The stem 414 is positioned within the center hole 406 in the bottom piece 404 of the lid 110. Beside the center hole 406 may be a plurality of smaller holes 416 in the bottom piece 404. A bottom perspective view of the lid 110, without illustration of the sealing member 412, is shown in FIG. 5.

So configured, the umbrella valve 408 is utilized in an upside down formation, because the vacuum is created within the reservoir 102 as compared to environmental pressure outside the reservoir 102 (e.g., atmospheric pressure), and the goal is to equalize the pressure within the reservoir 102 with the environmental pressure. The sealing disk 415 is configured to actuate to place the umbrella valve 408 in an open or closed state. In the closed state, the sealing disk 415 is configured to cover the holes 416, preventing air from entering the reservoir 102. In the open state, the sealing disk 415 is configured to move downward so that the holes 416 are not covered, allowing air to enter the reservoir 102. In certain embodiments, there may also be a small hole (not shown) in the top piece 402 of the lid 110 to expose the sealing disk 415 to the atmospheric pressure.

For example, the vacuum-release umbrella valve 408 is configured to open when the differential pressure in the reservoir 102, the difference between atmospheric pressure (about 101.3 kPa or 14.7 psi) and the vacuum pressure inside the reservoir 102, is greater than or equal to a preset opening pressure. When in the open state, the sealing disk 415 is forced downwards so that the holes 416 are not covered, allowing airflow between the environment and the reservoir 102 through the holes 416. The vacuum release umbrella valve 408 is closed when the differential pressure in the reservoir 102 is less than the preset opening pressure. When in the closed state, the sealing disk 415 covers the holes 416 to inhibit airflow between the environment and the reservoir 102.

During use of the device 100, without the porous body 106a, water can flow too quickly out of the water reservoir 102. Without the valve, which creates a vacuum, water can flow freely out of the porous body 106a via gravity, even if not inserted in soil. Thus, by using the porous body 106a in combination with the valve, the device 100 is a self-regulating, plant-directed, automatic plant watering device that supplies as much water as the plant needs and no more.

While the valve is illustrated and discussed above as being formed within the lid, alternative embodiments of the device can place the valve at different locations. For example, the valve can be positioned on an upper surface of the reservoir, such as adjacent to the lid.

A kit is disclosed including any embodiment of the watering device described above. The kit may include instructions for use.

### Fertilizer

The system, method, or kit disclosed herein may include a water-soluble fertilizer, which may be organic, synthetic, or a combination thereof. The water-soluble fertilizer may be in powder, tablet, or liquid form. The fertilizer may be quick dissolving (e.g., within about 120 seconds) without needed agitation or other processing to dissolve fully. The fertilizer is pre-portioned to dilute in the water reservoir after the addition of water to create a nutrient solution that may be slowly released into a plant, feeding the roots directly and consistently over time through the soil spike of the system disclosed herein. The release of the fertilizer into the plant through the soil spike is self-regulating, meaning that the speed of the release is controlled by the soil environment and the plant.

Many consumer water-soluble fertilizers today are quick release, which means that they are dissolved in water and poured into the plant all at once, which forces the plant to assimilate more nutrients than required at that time. This can lead to weak, leggy vegetative growth which can also lead to pest infestation and disease. The benefit to using a slow-release fertilizer is that the nutrients are released over time, allowing the soil to absorb the nutrients gradually.

Any pre-portioned quick-dissolving water-soluble NPK (Nitrogen, Phosphorous and Potassium) fertilizer may be used with the system disclosed herein. The NPK fertilizer may include, but is not limited to, urea (carbamide), dipotassium phosphate, sulfate of potash, dextrose, soy hydrolysate, calcium nitrate, sucrose. The NPK fertilizer may have any suitable ratio for house plants, for example, the ratio may be Oct. 10, 2010, 7-4-5, 4-1-3, or 6-1-4.

The fertilizer packet may be portioned to dissolve in the amount of water that may be contained by the water reservoir 102. For example, an approximately 5 gram tablet with NPK (e.g., 7-4-5, 4-1-3 or 6-1-4) will dissolve in a 750 mL water reservoir which holds 750 mL of water. Upon dissolution, this will produce a 750 mL nutrient solution that will feed a container plant in a 1-2 gallon container for about 2 weeks with no waste and without over or under fertilizing the plant.

In another example, two approx. 5 gram tablets with NPK (e.g., 7-4-5, 4-1-3 or 6-1-4) will dissolve in a 1.5 L water reservoir which holds 1.5 L of water. Upon dissolution, this will produce a 1.5 Liter solution to feed a container plant in a 3-5 gallon container for about 2 weeks.

### Methods of Use

The disclosure is directed to a method of self-watering of a plant over 1 or more weeks using embodiments of the device 100 for watering plants disclosed herein.

The method includes: assembling the device 100 for watering a plant; inserting the soil spike 106 of the assembled device 100 into soil beside a plant; adding water through the opening 104a at the top of the water reservoir 102; optionally adding a water soluble fertilizer into the water; and scaling the opening 104a by attaching the lid 110 in which the valve is formed. Assembly may include twisting the soil spike 106 onto the protruding edge 114 at the bottom end 102b of the water reservoir 102.

The method regulates the water flow out of the device 100 by using the water reservoir 102 sealed by the lid 110 with the water-permeable porous body 106a through which water slowly permeates. As the soil or other medium and root network of a plant draw moisture up its stem, water flows out of the device 100 via osmotic pressure, through the water-permeable porous body 106a, into the soil or other medium until it reaches equilibrium with the surrounding soil's moisture content.

The method may include opening the vacuum-release valve in the lid 110 once the internal pressure differential inside the reservoir 102 reaches a preset opening pressure.

The method may include watering the plant to ensure the soil is moist before inserting the assembled device 100 into soil beside a plant. The method may include waiting about 10 to about 30 minutes after adding water and optionally fertilizer to the device 100 before attaching the lid 110. The waiting time allows time for the porous body 106a to become saturated with water and start the osmotic chain before sealing the device 100 with the airtight lid 110. The soil and roots will slowly absorb the liquid solution from the water reservoir 102 based on the plant's individual needs, via equilibrium, until all of the liquid from the water reservoir 102 is depleted.

After depletion, the method includes: removing the lid 110 from the reservoir 102; adding water and optionally a fertilizer to the reservoir 102; optionally waiting about 10 to about 30 minutes; and resecuring the lid 110 on the water reservoir 102. For example, the device 100 including a 750 mL water reservoir 102 placed in plant in a 6-9 inch diameter container may continue to nourish the plant for about 2 weeks to about 1 month. In another example, the device 100 including a 250 mL water reservoir 102 placed in a 3-5 inch diameter container may continue to nourish the plant for about 2 weeks to about 1 month.

### Example

### Equilibrium Pressure Test

Tests of embodiments of the above-discussed plant watering device were performed to establish that combinations of lids with valves set to specific opening pressures and porous bodies with specific porosities are able to achieve an equilibrium state prior to insertion into soil. Equilibrium represents the condition where the reservoir 102 of the device 100 is filled with water and substantially inhibits water leakage when suspended in air.

The test conditions were as follows. The tests were conducted at an ambient temperature between 70° F.-75° F. using a devices having a reservoir filled to the top with water (filled to capacity). Two reservoir sizes were used: 750 mL and 250 mL. Thus, the volume of water within the 750 mL reservoir when filled was 750 mL and the volume of water within the 250 mL reservoir when filled was 250 mL. The protective outer body 106a of the 750 mL device was 5.25 inches in length and the porous body 106a was 3.5 inches in length. The protective outer body 106a of the 250 mL device was 3.5 inches in length and the porous body 106a was 2.5 inches in length

The sealed devices were initially tested outside of soil, with the porous body 106a formed of a porous ceramic material exposed to only open air, to confirm that the devices achieved the equilibrium state in air.

The porosity of the porous body and the thickness of the sealing disk 115 were varied, while the umbrella valve otherwise stayed constant. A no lid condition (open reservoir) and a fully sealed lid with no valve condition (closed reservoir) were also examined. A determination was subsequently made whether the device exhibited leaking or not.

For the no lid condition, no vacuum is developed within the reservoir. Therefore, only the porosity of the porous body affects the rate of water flow from the reservoir. In general, as the porosity of the porous body increased, the rate of flow from the reservoir increases. Equilibrium conditions were not obtained over a range of different porous body porosities.

For the no valve condition, a vacuum is developed within the reservoir with no mechanism for release. This vacuum significantly affects the rate of water flow from the reservoir, along with the porosity of the porous body. Equilibrium conditions were obtained for all porosities.

The condition for equilibrium/substantially no leakage was determined by the volume of the reservoir and a minimum time duration to deplete the water from the device due to effects other than soil/medium and plant root pressure.

For example, assuming a three week (21 day) time duration for the 750 mL volume reservoir device, the condition for no leaking was established as less than 35 mL of water leakage occurring within a 24 h period. This is less than 735 mL over a three week period, which is less than the reservoir capacity. When greater than 35 mL of water leakage occurred within a 24 h period, leaking was determined to occur. Thus, this equilibrium condition ensures that leakage does not deplete all water from the device over the minimum time duration.

Similarly, for a 250 mL volume reservoir device, the condition for no leaking was established as less than 15 mL of water leakage occurring within a 24 h period. While 250 mL/12 mL would represent about 3 weeks, this value is rounded to 15 mL for ease of calculation. When greater than 15 mL of water leakage occurred within a 24 h period, leaking was determined to occur.

Under the no lid (open reservoir) configuration, the porosity of the porous body 106a can be varied to deliver water from the reservoir 102 under only the force of atmospheric pressure. That is, no vacuum pressure is developed within the reservoir 102 because the reservoir 102 is open to atmosphere. In general, the flow rate of water from the reservoir 102 increases with increasing porosity of the porous body 106a. The porosity of the porous body 106a was varied to achieve flow rates in the no-lid condition between about 10 mL/h to about 120 mL/h in the 750 mL device and between about 10 mL/h to about 75 mL/h in the 250 mL device.

These results showed that combinations of valve opening pressure and porous body porosity for a given reservoir volume (water height) can achieve equilibrium within the device. This result is significant, as it can be expected once an equilibrium device is inserted in soil, the soil and/or root system of an adjacent plant will apply pressure to draw water from the device.

Accordingly, further testing was performed in soil using 250 mL and 750 mL for devices in equilibrium having a range of different combination of valve opening pressures and porosity of the porous body 106a. These equilibrium devices were placed into soil next to common houseplant species and tested in situ to determine which combinations of valve opening pressure and porous body porosity for a given reservoir volume (water height) were best suited to the average houseplant, both indoors and outdoors.

Results further showed that combinations of valve opening pressure and porous body porosity for a given reservoir volume (water height) can achieve target flow rates that lie within a range suitable for average houseplants, both indoors and outdoors.

It can be appreciated that, not all combinations of valve opening pressure and porous body porosity for a given reservoir volume (water height) can achieve target flow rates, however. For a given volume of the water reservoir (water height), higher valve opening pressure and lower porous body porosity each tend to reduce the flow rate of water from the device. That is, higher valve opening pressure supports development of a higher vacuum pressure within the reservoir, which tends to restrict water flow from the reservoir, while lower porosity requires greater pressure to drive water through the porous body, also tending to restrict water flow from the reservoir. Additional results showed that devices with higher opening pressure lid valves coupled with low spike porosities could cause underwatering in thirstier plants since it would be harder for those plants to absorb water from a reservoir that continues to build vacuum over a longer period of time before the valve is opened.

Similarly, for a given volume of the water reservoir (water height), lower valve opening pressure and higher porous body porosity each tend to increase the flow rate of water from the device. Further results showed that devices with lower opening pressure lid valves may cause overwatering in less thirsty plants such as succulents.

Accordingly, the opening pressure of the valve and the porosity of the porous body can be configured, based on the volume of the reservoir (water height) to provide a selected flow rate of water from the reservoir to the soil that avoids either overwatering or underwatering.

Approximating language, such as “about,” “approximately,” “substantially,” or equivalents, as used herein throughout the specification and claims, may be applied to modify any quantitative representation that could permissibly vary without resulting in a change in the basic function to which it is related. Accordingly, a value modified by approximating language are not to be limited to the precise value specified. In at least some instances, the approximating language may correspond to the precision of an instrument for measuring the value. In other instances, the approximating language can encompass a percentage range greater than and less than the precise value specified (e.g., +5%).

Range limitations presented in the specification and claims may be combined and/or interchanged, such ranges are identified and include all the sub-ranges contained therein unless context or language indicates otherwise.

Although the present invention has been described with reference to various aspects of the invention, those of ordinary skill in the art will recognize that changes may be made in form and detail without departing from the spirit and scope of the invention.

What is claimed:

1. A plant watering device, comprising:
a reservoir configured to hold water therein and having a first opening at one end and a second opening at the opposing end;
a porous body covering the second opening, wherein the porous body provides a flow pathway from the reservoir; and
valve covering the first opening of the reservoir, wherein the valve is configured to close to inhibit airflow between the reservoir and an external environment when a differential pressure between the reservoir and atmospheric pressure is less than a preset opening pressure and is configured to open to permit airflow between the reservoir and the external environment when the differential pressure is greater than or equal to the preset opening pressure;
wherein when the reservoir contains water and is inserted in a medium to be watered, an opening pressure of the valve and the porosity of the porous body are configured to provide a selected flow rate of water from the reservoir to the medium to be watered.

2. The device of claim 1, wherein the first opening of the reservoir is dimensioned to permit receipt of water therein to fill the reservoir, and wherein the valve is formed within a lid.

3. The device of claim 1, wherein the porous body is a hollow cone.

4. The device of claim 3, further comprising a soil spike including the hollow cone and a hollow conical outer protective body that is configured to receive the porous body and to detachably connect to the second opening of the reservoir.

5. The device of claim 4, wherein the outer protective body is in the form of a spike that comprises a plurality of struts and apertures therebetween.

6. The device of claim 1, wherein the valve is a one-way valve.

7. The device of claim 1, wherein the valve is an umbrella valve.

8. The device of claim 1, wherein the porous body is formed from one or more ceramic materials.

9. The device of claim 1, wherein the porous body is formed from at least one of alumina (Al₂O₃), silica (SiO₂), lime (CaO), magnesia (MgO), hematite (Fe₂O₃), soda (Na₂O), titania (TiO₂), or potash (K₂O).

10. The device of claim 1, wherein, absent the valve, the porous body has a porosity configured to result in delivery of water from the reservoir under only the force of atmospheric pressure at a flow rate ranging between about 10 mL to about 120 mL per hour.

11. The device of claim 1, wherein the reservoir is configured to hold a volume selected from the range between about 50 mL to about 2 L.

12. A kit for delivering water and nutrients to a container plant comprising the plant watering device of claim 1, and a water-soluble fertilizer.

13. The kit of claim 12, wherein the water-soluble fertilizer fully dissolves in water within about 60 seconds.

14. The kit of claim 12, wherein the water-soluble fertilizer is provided in pre-apportioned tablet or powder form.

15. A method of watering a plant comprises:
assembling the device of claim 4;
inserting the soil spike of the assembled device into soil beside the plant;
adding water through the first opening at the top of the reservoir; and
sealing the opening by attaching a lid in which the valve is formed;
wherein the water permeates through the porous body for a period of time over 1 week.

16. The method of claim 15, further comprising adding a water soluble fertilizer into the water prior to sealing the opening.

17. The method of claim 15 further comprising waiting about 10 to about 30 minutes after adding water, then refilling to the capacity of the reservoir before sealing with the lid.

18. The method of claim 15, wherein the water permeates through the porous body and nourishes the plant for a period of time over 2 weeks.

19. The method of claim 15, wherein the water permeates through the porous body and nourishes the plant for a period of about 2 to about 4 weeks.

20. The method of claim 15, wherein after depletion of the water from the reservoir, the method further comprises:
removing the lid;
adding water through the first opening at the top of the reservoir;
optionally waiting about 10 to about 30 minutes; refilling to the capacity of the reservoir, and
sealing the opening by attaching the lid.
